(19) United States
(12) Patent Application Publication
(10) Pub. No.: US 2019/0132276 A1
(43) Pub. Date: May 2, 2019

(54) UNIFIED EVENT PROCESSING FOR DATA/EVENT EXCHANGES WITH EXISTING SYSTEMS

(71) Applicant: SAP SE, Walldorf (DE)

(72) Inventors: Christoph Scheiber, Reilingen (DE); Tatjana Pfeifer, Altrip (DE); Andreas Hoffner, Ostringen (DE)

(21) Appl. No.: 15/978,877

(22) Filed: May 14, 2018

Related U.S. Application Data
(60) Provisional application No. 62/580,737, filed on Nov. 2, 2017.

(51) Int. Cl. H04L 12/58

(52) U.S. Cl. CPC H04L 51/36; G06F 17/30292

(57) ABSTRACT

The present disclosure involves systems, software, and computer implemented methods for unified event processing for existing systems. One example method includes receiving, in an application server, an event from an event emitter. An event type for the event is determined. A channel is identified for publication of the event to an external system, based on the identified event type. A messaging protocol associated with the channel is identified. A connection associated with the channel is identified. A topic is determined based on the event type and the identified channel. An event payload of the event is transformed into a message. The message is in a format specified by the messaging protocol. The message and the topic are sent to the external system, over the identified connection.

### CLAIM OF PRIORITY

This application claims priority under 35 USC § 119(e) to U.S. Provisional Patent Application Ser. No. 62/580,737, filed on Nov. 2, 2017, the entire contents of which are hereby incorporated by reference.

### TECHNICAL FIELD

The present disclosure relates to computer-implemented methods, software, and systems for providing unified event processing for existing systems.

### BACKGROUND

Reactive programming focuses on computation through ephemeral dataflow chains, which are typically event-driven. Reactive systems can focus on resilience and elasticity through the communication, and coordination, of distributed systems, using messaging. Event publishers can publish events, with a given event having a particular topic. Event subscribers can subscribe to receive events of various topics. When an event publisher publishes an event of a topic that has one or more subscribers, the messaging system can deliver the event asynchronously to the event subscribers.

### SUMMARY

The present disclosure involves systems, software, and computer implemented methods for providing unified event processing for existing systems. One example method includes receiving, in an application server, an event from an event emitter. An event type for the event is determined. A channel is identified for publication of the event to an external system, based on the identified event type. A messaging protocol associated with the channel is identified. A connection associated with the channel is identified. A topic is determined based on the event type and the identified channel. An event payload of the event is transformed into a message. The message is in a format specified by the messaging protocol. The message and the topic are sent to the external system, over the identified connection.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for eventing in a cloud platform.

FIG. 2 is a block diagram illustrating an example system for enabling eventing scenarios involving an application server.

FIG. 3 illustrates an example system for enabling sharing of events between an application server and a cloud platform.

FIG. 4 illustrates an example system for event enablement in an application server.

FIG. 5 is a flowchart of an example method for sending an event from an application server to an external system.

### DETAILED DESCRIPTION

Existing systems can contribute to extension scenarios built using a cloud platform. To ensure high availability in cloud scenarios/applications, existing systems may be required to support reactive programming and/or interface with reactive systems. Existing systems may not include an efficient way to exchange events with external systems. For example, existing systems may lack publish-subscribe based messaging scenarios (e.g. via message brokers). Current solutions for event management for existing systems may be mostly on a point to point basis and may be either realized via polling event sources on a regular basis or via direct push calls to event receivers. Current solutions may be described by communication channels, a way of distributing events and payload formats in which event data is exchanged. Current solutions may be based on individual contracts between event receivers and event sources which can lead to individual solutions, which can result in high costs in development and during maintenance, complex interfaces, and multiple point to point connections which can be error-prone.

The exchange of events has become more and more important and plays an important role in building extension scenarios for already existing systems, e.g. in the cloud or in other external systems. Traditional approaches to exchange events may not be manageable when dealing with a large number of events and extensions.

A new unified event processing framework can be introduced to exchange events in existing systems with external systems. The event processing framework can utilize a publish-subscribe messaging approach in which events are exchanged as a message which consists of a payload and a topic. A unified topic syntax can be introduced that is well-defined, follows a path-based approach (e.g., an example topic may be “BO/SO/Created”), and allows a translation into different protocol-specific formats (e.g., AMQP (Advanced Message Queuing Protocol), MQTT (Message Queuing Telemetry Transport). Events can be described by structures known to the existing system, which can allow for extraction of metadata and schema information in different formats (e.g., JSON (JavaScript Object Notation) Schema). Connection settings such as reliable and/or exclusive connections can be offered, which can allow for protocol-agnostic processing.

The event processing framework can enable service implementations that publish and/or consume events. A registry can be provided that allows for registering event service implementations using a well-defined interface. An event service implementation can publish and/or consume events and provide event browsing capabilities with dedicated topic space(s) to clearly separate events.

The event processing framework can enable topic browsing. An event service implementation can provide event browsing capabilities (using a well-defined interface) to enable the retrieval of a list of events (including schema information) that are raised from an event source. An event tracker can be used to observe events, including the tracking of event publication, receipt, acknowledgement, and republishing. Events can be recorded, statistics can be derived from recorded events, and recorded events can be replayed. An event consumer can configure a channel for event exchanges, including configuration information for external brokers and an underlying message protocol (e.g., MQTT). An event discovery service provided by an event enablement component can allow the developer of an event-consuming application to browse available events and to explore event metadata. Events can become visible in the event discovery service as soon as an event emitter exposes events in a service implementation and whitelists the events on an application server.

Channel bindings functionality can include bindings of channels to topics raised by a service implementation which are to be forwarded to a channel by a unified event processing runtime. The event processing framework can provide, for example, a well-defined format, e.g., an OData/Rest (REpresentational State Transfer) interface, for event discovery, a runtime manager for forwarding events to corresponding channels based on bindings, communication channels for establishing connections with external message brokers (e.g., MQTT) and to allow event background event exchanges (e.g., with daemon processes).

The event processing framework can provide the following advantages: a unified way to exchange events between existing and external systems in an asynchronous and scalable manner; a unified way for describing events including schema and topic descriptions; enabling exploration of events at design time (e.g., using external tooling); enabling plugin functionality for event service providers and consumers; enabling plugin functionality for channels that translate events into messages using different protocols; support different messaging protocols; and enabling cloud extension developments. Channels may also support other (non-messaging) protocols such as REST-APIs or SOAP (Simple Object Access Protocol) services or remote function calls. Further, event unification allows a consuming application to consume events irrespective of an event origin platform and format. An event enablement component can transform an event or topic into a standardized format and a well-defined hierarchy, use a standard messaging protocol, offer event metadata in a platform independent and standardized manner, and provide a consumption and provisioning API (Application Programming Interface). A rule-based and subscription-based channel-binding configuration can be used to define what channels are used for which events.

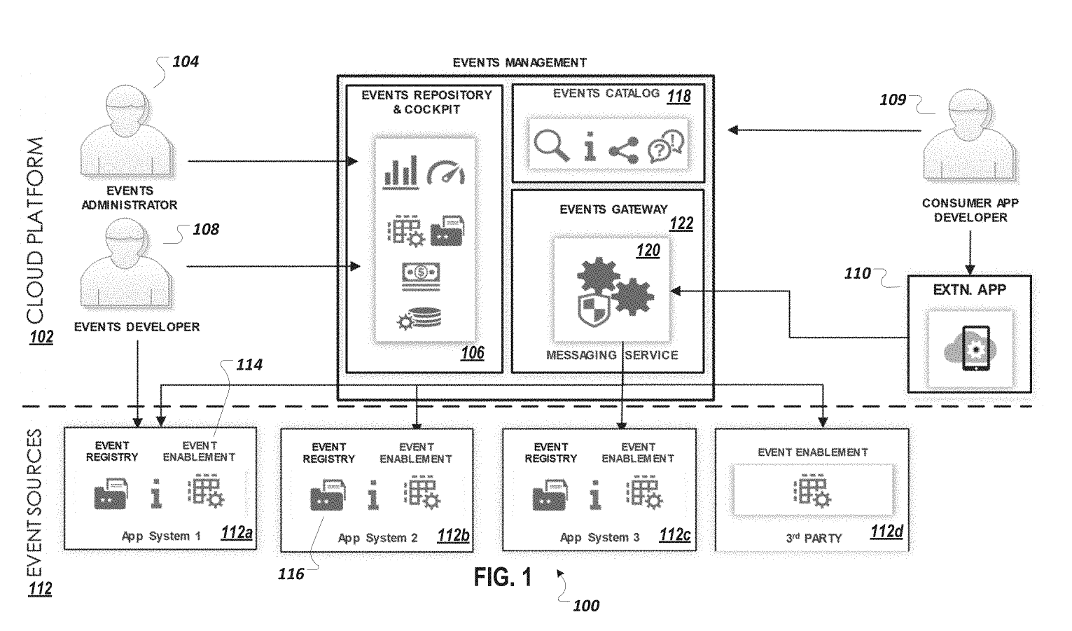

FIG. 1 is a block diagram illustrating an example system 100 for eventing in a cloud platform 102. The cloud platform 102 is configured to support events. An events administrator 104 can configure events in an event repository 106, including binding events to channels, and other tasks. An events developer 108 can develop cloud applications that generate events. A consumer application developer 109 can develop a cloud extension application 110 that consumes events—e.g., the cloud extension application 110 can be configured to receive and react to events published within the cloud platform 102 and/or events received from external event sources 112. The cloud extension application 110 can be an extension for a business process. The cloud extension application 110 can be an event producer as well as an event receiver.

Each event source 112a, 112b, 112c, or 112d may want to publish and/or receive events. Each event source 112a, 112b, 112c, or 112d can be a different type of system and can include a respective event enablement component (e.g., an event enablement component 114) to enable events to be published to the cloud platform 102 and/or received from the cloud platform 102.

Each event enablement component can enable events generated internally in an event source 112a, 112b, 112c, or 112d to be published to the cloud platform 102. Event emitters that had previously been internal to a respective event source 112 can now have their events published to external systems, e.g., for supporting development of cloud extensions in the cloud platform 102. Respective event enablement components in the event sources 112 can enable the respective event sources 112 to participate in publish/subscribe scenarios with external systems, including cloud applications such as the extension application 110. A respective event enablement component can transform an event and topic into a standardized event format and a well-defined hierarchy topic hierarchy. Event enablement components can send events using a standard messaging protocol used by the cloud platform 102. Each event enablement component can provide event metadata in a platform independent and standardized manner.

Each event source 112a, 112b, 112c, or 112d can have an event registry (e.g., an event registry 116). Information about available events in respective event registries can be shared with the cloud platform 102, and can be stored in an event catalog 118. The consumer application developer 109 can use the events catalog 118 to discover events that may be generated from within the cloud platform 102 or from one of the event sources 112. As described in more detail below, a messaging service 120 in an events gateway 122 can be used for transmission of events between the cloud platform 102 and the event sources 112.

The events gateway 122 enables different types of event sources 112 and systems to participate in unified eventing scenarios in the cloud platform 102. Various internal and external systems can receive and publish events after the events have been bound and enabled using event frameworks in the cloud platform 102 and/or the event sources 112. The eventing frameworks can provide event unification that allows consuming cloud and other applications to consume events irrespective of their origin platform and format.

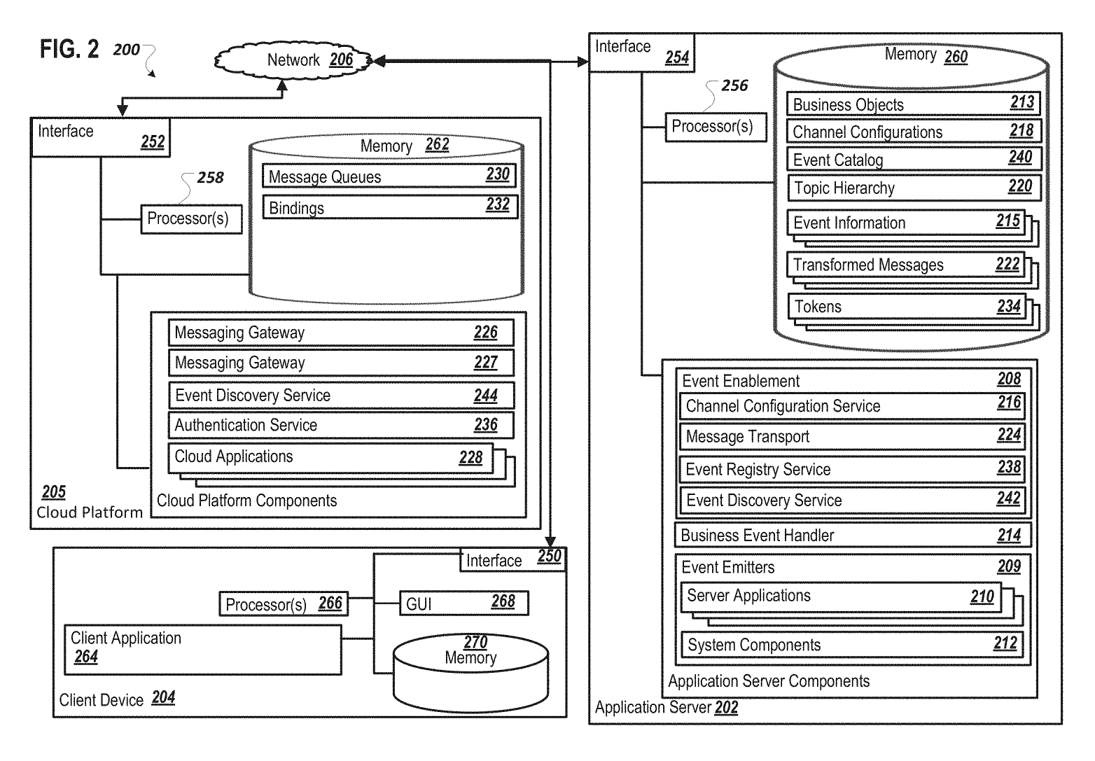

FIG. 2 is a block diagram illustrating an example system 200 for enabling eventing scenarios involving an application server 202. Specifically, the illustrated system 200 includes or is communicably coupled with the application server 202, a client device 204, a cloud platform 205, and a network 206. Although shown separately, in some implementations, functionality of two or more systems or servers may be provided by a single system or server. In some implementations, the functionality of one illustrated system or server may be provided by multiple systems or servers.

An event enablement component 208 in the application server 202 can enable the application server 202 to participate in eventing scenarios with other, external systems, such as the cloud platform 205. Event emitters 209, such as server applications 210 or system components 212 (e.g., a database, a server system process) can generate events which can be exposed to external systems. An event can be a change to a business object 213, for example.

A business event handler 214 can receive event information 215 from internal components such as the event emitters 209, and forward the event information 215 to the event enablement component 208. The event enablement component 208 can determine an event type included in or otherwise associated with the received event information 215. A channel configuration service 216 can determine whether one or more channels have been bound to the event type, in channel configuration data 218. A channel represents a connection to an external system that can be used for communication between the application server 202 and the external system.

The event enablement component 208 can determine a topic for an outgoing message, from a topic hierarchy 220, based on the event type and the channel. A topic can describe an event and can be used for event routing. Each channel can be associated with a particular messaging protocol (e.g., MQTT or some other protocol). The event enablement component 208 can transform event information 215 into a transformed message 222 that includes an event payload and the determined topic. Each transformed message 222 can be in a format that is specific to the messaging protocol that will be used to transport the message.

A message transport layer 224 can identify a connection associated with the channel and can send the transformed message to the cloud platform 205, over the identified connection. The transformed message can be received in the cloud platform 205 by a messaging gateway 226. The messaging gateway 226 can forward the received message to a messaging broker 227. The messaging broker 227 can route the transformed message to one or more cloud applications 228 or message queues 230, based on topic bindings 232. Cloud applications 228 can subscribe to certain message topics and read messages from the message queues 230.

In some implementations, tokens 234 are used when sending messages from the application server 202 to the cloud platform 205. Before establishing a connection for message sending, the application server 202 can send a request for a token to an authentication service 236 associated with the cloud platform 205. The authentication service 236 can provide a token in response to the token request. A token 234 can be included in subsequent messages sent from the application server 202 to the cloud platform 205. Tokens can be used for authentication of an event source at the cloud platform 205. A token can include a service instance identifier to ensure that the event source connects to an appropriate service instance.

Before events are generated in the application server 202, event types can be registered at design time using an event registry service 238. Event metadata (e.g., event payload, structure) that describes events that may be generated can be provided to the event registry service 238 by event emitters 209 and stored in an event catalog 240. At run time, the event enablement component can, before sending an event to the cloud platform 205, determine that runtime event data corresponds to previously-specified design time event metadata.

As described in more detail below, the application server 202 and the cloud platform 205 can respectively include an event discovery service 242 or an event discovery service 244, to enable discovery of events exposed by respective systems. The event discovery service 242 can enable external applications to discover events described in the event catalog 240, for example. A given server application 210 can be an event producer, an event consumer, or both an event producer and an event consumer, with respect to external systems, using the event enablement component 208.

As used in the present disclosure, the term “computer” is intended to encompass any suitable processing device. Indeed, the application server 202 and the cloud platform 205 may be or include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the application server 202 may be adapted to execute any operating system, including Linux, UNIX, Windows, Mac OS®, Java™, Android™, iOS or any other suitable operating system. According to one implementation, the application server 202 may also include or be communicably coupled with an e-mail server, a Web server, a caching server, a streaming data server, and/or other suitable server.

Interfaces 250, 252, and 254 are used by the client device 204, the cloud platform 205, and the application server 202, respectively, for communicating with other systems in a distributed environment—including within the system 200—connected to the network 206. Generally, the interfaces 250, 252, and 254 each comprise logic encoded in software and/or hardware in a suitable combination and operable to communicate with the network 206. More specifically, the interfaces 250, 252, and 254 may each comprise software supporting one or more communication protocols associated with communications such that the network 206 or interface's hardware is operable to communicate physical signals within and outside of the illustrated system 200.

The application server 202 and the cloud platform 205 respectively include processor(s) 256 or 258. Each of the processor(s) 256 and 258 may be a central processing unit (CPU), a blade, an application specific integrated circuit (ASIC), a field-programmable gate array (FPGA), or another suitable component. Generally, each of the processor(s) 256 and 258 executes instructions and manipulates data to perform the operations of the application server 202 or the cloud platform 205, respectively.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 2 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The application server 202 and the cloud platform 205 respectively include memory 260 or 262. The memory 260 and 262 may include any type of memory or database module and may take the form of volatile and/or non-volatile memory including, without limitation, magnetic media, optical media, random access memory (RAM), read-only memory (ROM), removable media, or any other suitable local or remote memory component. The memory 260 and 262 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the application server 202 or cloud platform 205, respectively. In some implementations, the application server 202 and/or the cloud platform 205 include multiple memories.

The client device 204 may generally be any computing device operable to connect to or communicate with the application server 202 via the network 206 using a wireline or wireless connection. In general, the client device 204 comprises an electronic computer device operable to receive, transmit, process, and store any appropriate data associated with the system 200 of FIG. 2. The client device 204 can include one or more client applications, including a client application 264. A client application is any type of application that allows the client device 204 to request and view content on the client device 204. In some implementations, a client application can use parameters, metadata, and other information received at launch to access a particular set of data from the application server 202. In some instances, the client application 264 may be an agent or client-side version of a server application 210. In some instances the client device 204 is an administrator or developer client device and the client application 264 enables the administrator or developer to configure eventing information in the application server 202.

The client device 204 further includes one or more processors 266. Each processor 266 included in the client device 204 may be a central processing unit (CPU), an application specific integrated circuit (ASIC), a field-programmable gate array (FPGA), or another suitable component. Generally, each processor 266 included in the client device 204 executes instructions and manipulates data to perform the operations of the client device 204. Specifically, each processor 266 included in the client device 204 executes the functionality required to send requests to the application server 202 and to receive and process responses from the application server 202.

The client device 204 is generally intended to encompass any client computing device such as a laptop/notebook computer, wireless data port, smart phone, personal data assistant (PDA), tablet computing device, one or more processors within these devices, or any other suitable processing device. For example, the client device 204 may comprise a computer that includes an input device, such as a keypad, touch screen, or other device that can accept user information, and an output device that conveys information associated with the operation of the application server 202, or the client device 204 itself, including digital data, visual information, or a graphical user interface (GUI) 252.

A GUI 268 of the client device 204 interfaces with at least a portion of the system 200 for any suitable purpose, including generating a visual representation of the client application 208. In particular, the GUI 268 may be used to view and navigate various Web pages. Generally, the GUI 268 provides the user with an efficient and user-friendly presentation of business data provided by or communicated within the system. The GUI 268 may comprise a plurality of customizable frames or views having interactive fields, pull-down lists, and buttons operated by the user. The GUI 268 contemplates any suitable graphical user interface, such as a combination of a generic web browser, intelligent engine, and command line interface (CLI) that processes information and efficiently presents the results to the user visually. The GUI 268 is optional as event messaging can occur without user intervention between background processes.

Memory 270 included in the client device 204 may include any memory or database module and may take the form of volatile or non-volatile memory including, without limitation, magnetic media, optical media, random access memory (RAM), read-only memory (ROM), removable media, or any other suitable local or remote memory component. The memory 270 may store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client device 204.

There may be any number of client devices 204 associated with, or external to, the system 200. For example, while the illustrated system 200 includes one client device 204, alternative implementations of the system 200 may include multiple client devices 204 communicably coupled to the application server 202 and/or the network 206, or any other number suitable to the purposes of the system 200. Additionally, there may also be one or more additional client devices 204 external to the illustrated portion of system 200 that are capable of interacting with the system 200 via the network 206. Further, the term “client”, “client device” and “user” may be used interchangeably as appropriate without departing from the scope of this disclosure. Moreover, while the client device 204 is described in terms of being used by a single user, this disclosure contemplates that many users may use one computer, or that one user may use multiple computers.

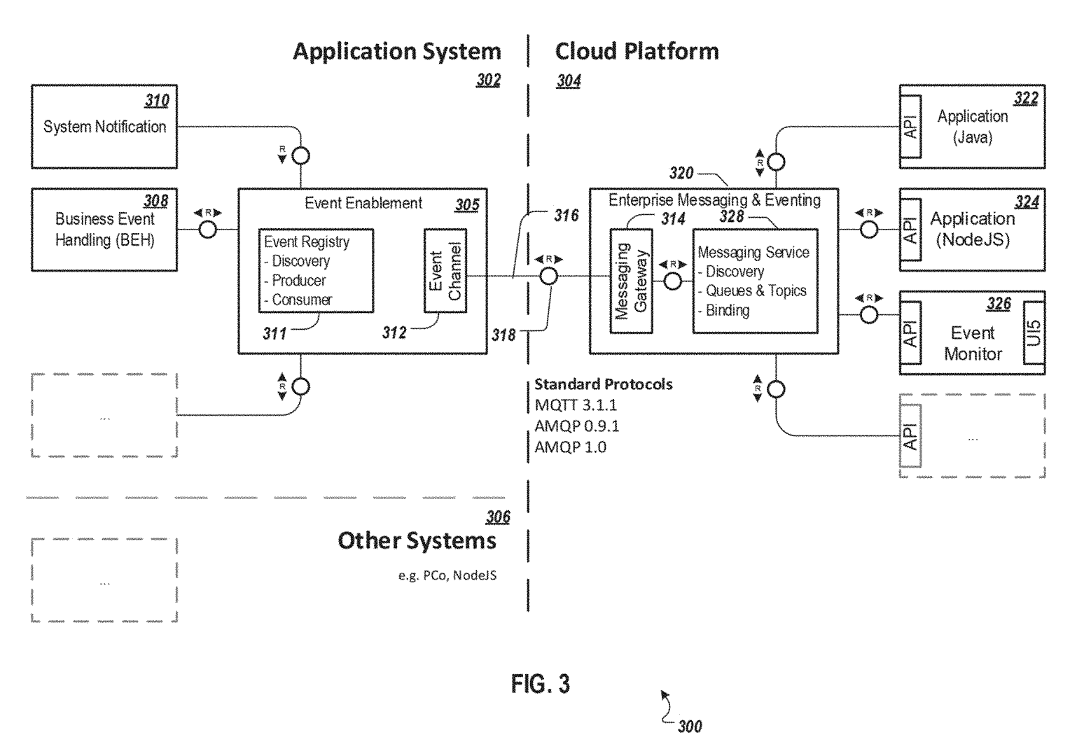

FIG. 3 illustrates an example system 300 for enabling sharing of events between an application server 302 and a cloud platform 304. The application server 302 is configured to exchange events with the illustrated cloud platform 304, or with any other system that can, for example, establish an MQTT connection (e.g., any system that includes a MQTT message broker). Although MQTT is discussed, other types of protocols can be used.

An event enablement infrastructure 305 can be added to the application server 302 to enable the application server 302 to send messages to the cloud platform 304 (and other systems 306). The eventing infrastructure 305 can enable the exposure of events in a controlled and managed way, by being a central component within the application server 302 that externally exposes events and event metadata to external systems. The event enablement infrastructure 305 can provide unified eventing, enabling event sources in the application server 302, that had previously only sent messages internally, to send messages to external systems, and enabling the same or other application server components to be recipients of events sent from other systems.

For example, before the adding of the event enablement infrastructure 305, the application server 302 may have had internal eventing components, such as workflow components, that generated events for internal distribution within the application server 302. The internal eventing components can be integrated with the event enablement infrastructure 305, to enable the internal eventing components to send and receive events to and from the cloud platform 304. Asynchronous messages can be pushed by the internal event sources, which can replace subscriber-driven polling mechanisms. Events can be distributed to multiple subscribers in a target system even though the event is sent once to the target system. Event distribution to the multiple subscribers can be performed by a message broker in the target system.

Various types of events can occur in the application server 302. For example, business-related and system-related events can occur. A business event handling component 308 can generate business-related events based on detection of business-related conditions (e.g., a changing of a sales order). A system notification component 310 can generate a system-related event based on detection of a system condition within the application server 302 (e.g., a system status). The business event handling component 308 and the system notification component 310 can send event data to the event enablement component 305. Event data can include an event payload and an event type.

Events that may be generated within the application server 305 can be registered in an event registry 311, e.g., by specifying which event types may be generated by event producers in the application server 305. As mentioned, application server components 305 can be event consumers as well as event producers. An event consumer can use the event registry 311 to register an event handler and subscribe to certain types of events. Events that an event consumer has subscribed to can be dispatched to the particular even consumer after they are received from external systems by the event enablement component 305.

For an outgoing event, the event enablement component 305 can identify, based on the type of the event, one or more event channels 312 for publication of the event to one or more external systems such as the cloud platform 304. An event channel 312 represents a single connection to an external system that can be used for communication between the application server 302 and the external system.

Event types can be bound to event channels 312. At run time, when an event is raised, the event enablement component 305 can find event channel(s) 312 that are bound to the type of the received event. The event enablement component 305 can look up event binding for the event type to identify an event channel 312 bound to the event type, if an event channel 312 bound to that event type is active, and create an event channel 312 and bind the created event channel 312 to the event type if an event channel 312 bound to the event type is not active. The event can then be dispatched over those event channel(s) 312 that are bound to the event type.

The event enablement component 305 can enable definition and configuration of event channels 312. Configuring an event channel 312 can include specifying an event type, an end point (e.g., that points to a messaging gateway 314 or another message broker), credentials for the end point, and a protocol. An event channel 312 can be associated with the web socket protocol and MQTT on top of the web socket protocol for exchanging messages with the cloud platform 304, for example. Other protocols can be supported. An event channel 312 can be assigned to a particular service instance within the cloud platform 304.

Multiple event channels 312 can be defined that use different protocols and different targets. An application that raises an event can be unaware exactly how that event is routed to an external system. Different event channels 312 may be used, each with different processing. For example, a remote function call channel can involve the calling of a remote function, rather than the sending of messages to a message broker, which may be done for MQTT or other types of channels. Multiple event channels 312 can be bound to a same event type, which can enable messages of the same event type being published to multiple external systems or multiple service instances of a system.

Identifying an event channel 312 can include identifying a messaging protocol associated with the event channel 312. Each event channel 312 can be associated with one transport protocol for example. Different messaging and transport protocols can be supported with specific channel implementations (e.g., MQTT, AMQP, remote function calls, others). Events can be sent across various types of event channels 312 without the need for application server 305 applications to be aware of which event channel 312 is used, or for applications to be changed to support new or different type of event channels 312.

For each identified event channel 312 that is to be used for an event, the event enablement component 305 can identify a connection associated with the respective identified event channel 312. The event enablement component 305 can either establish or identify an existing connection (e.g., a connection 316). For example, the event enablement component 305 can determine whether an open connection exists that corresponds to the identified event channel 312, and establish a connection if an open connection for the identified event channel 312 does not exist. Once established, connections for channels can generally remain open, to enable sending of multiple events, over time, without requiring re-establishment of the connection.

The event enablement component 305 can handle the keeping of the connection 316 open between the application server 302 and the cloud platform 304. Event sources in the application server 305 don't need to handle management of the connection. Connection management can be performed centrally within the event enablement component 305, rather than within multiple event sources.

The event enablement component 305 determines a topic based on the event type and the identified channel. A topic can be a description for an event, and a given event can be assigned to one topic. Topics can be used to dispatch messages to appropriate targets. A unified topic syntax can be used so that topic names can be stable even if underlying protocols used to transport messages change. Topic names can include multiple, separated segments, that can form a logical tree of topics, for topic organization. Topics can be used at run time to control the flow of data between the application server 305 and other systems.

The event enablement component 305 can transform an event payload of the event and the topic into a message 318, with the message 318 being in a format specified by the messaging protocol used for the connection 316. The message 318 is sent over the connection 316 to the messaging gateway 314. The event enablement component 305 can send, for example, a MQTT message, over a web socket connection, to the cloud platform 304 or to other systems that can receive an upgrade request for establishing a web socket connection, for example. Web socket connections are optional—e.g., traditional TCP (Transmission Control Protocol) connections can be used, without the use of web sockets.

The messaging gateway 314 is part of an enterprise messaging and eventing component 320 included in the cloud platform 304. The messaging gateway 314 can be an endpoint that is addressed by the application server 302 when a message is sent from the application server 302. A messaging broker connected to the messaging gateway 314 can forward the event message, based on event configuration and bindings, to a bound consumer application. The cloud platform 304 can include consuming cloud applications, which can be written in various languages, that can consume events received from the application server. Example consuming applications include a Java application 322, a NodeJS (Node JavaScript) application 324, and an event monitor application 326.

Cloud applications can be instances of services. The messaging gateway 314 can route messages to messaging hosts associated with the service instances, based on credentials (e.g., represented as a token) or routing information in a received message. A messaging host can be a broker instance, which can be a virtual broker associated with a shared message broker or an exclusive instance of a message broker. A messaging host in the cloud platform 304 can handle messages for a particular customer. A cloud application can be associated with a messaging host that is a logical instance of an enterprise messaging service and which represents an isolated messaging area for the cloud application. Multiple cloud applications can be bound to the same messaging host and can exchange messages

Cloud applications can subscribe to messages by topic, using a messaging service 328. A cloud application can subscribe to one or more topics and can receive messages of a subscribed-to topic when the cloud application is online. A cloud application can also be bound to a queue, with the queue subscribing to and receiving messages on behalf of the cloud application, even when the cloud application is not online. When the cloud application comes online, the cloud application can read messages from the queue. The queue can hold messages on behalf of the cloud application, so that the cloud application does not miss any messages due to being offline.

In addition to run-time message sending and receiving, the system 300 can include design-time aspects which enable the application server 302 and the cloud platform 304 (and other systems) to discover events that are published by a respective system. Features below are described for the event registry 311, but the messaging service 328 in the cloud platform can provide similar discovery mechanisms that enable the application server 302 to discover events published by applications in the cloud platform 304. The event registry 311 in the event enablement component 305 enables external applications (e.g., applications in the cloud platform 304 or in other systems) to query the application server 302 to discover events that are exposed by the application server 302, and corresponding metadata for exposed events.

A cloud extension developer can discover events that are sent from the application server 302, including message payload structure information. The cloud extension developer can use the discovered information to implement a cloud extension that participates in messaging with application server 302 components. A topic browser can be provided by the event registry 311 that enables navigation through and discovery of topics in a topic hierarchy. The topic browser can be used to discover a payload structure for events of a particular topic. Events can become visible inside the event registry 311 as soon as an event emitter exposes the event in a service implementation and whitelists the event on the application server 302.

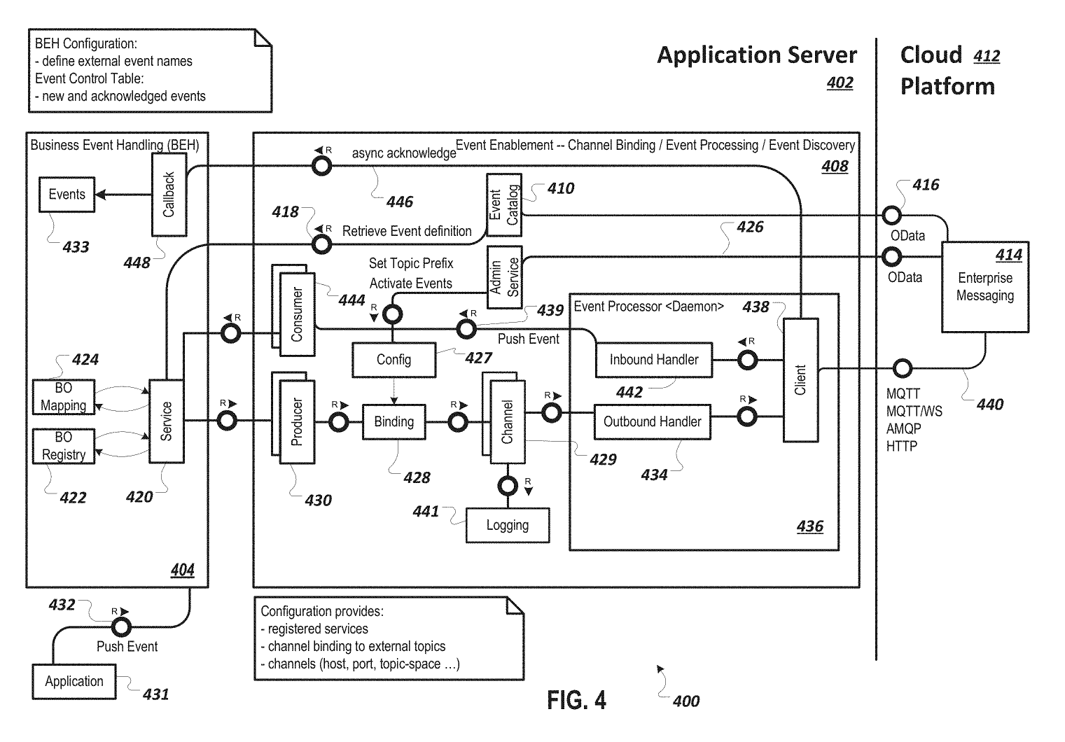

FIG. 4 illustrates an example system 400 for event enablement in an application server 402. A business event handling component 404 allows application server 402 components to register events. An event enablement component 408 includes an event catalog 410 that is made available to external systems, such as a cloud platform 412, using, for example, an event discovery OData service. The event catalog 410 can be an OData service implementation which is used to retrieve event metadata for event service implementations. An enterprise messaging service instance 414 can use the event discovery OData service to send an event discovery request 416 to discover events in the event catalog 410 that are exposed by the application server 402. The event discovery OData service can enable cloud applications or developers to browse event definitions of events produced by the application server 402.

In response to an event discovery request, the event catalog 410 can send a request 418 to an eventing service implementation 420 in the business event handling component 404 to retrieve event definition(s). The event service implementation 420 can be provided by an application that is configured to emit event(s). The eventing service implementation 420 can retrieve event information from a business object registry 422 and a business object mapping 424. The business object mapping 424 can map business objects to external representations within events. An event can occur due to a change in a business object, for example.

An administrative OData service can be used to activate and deactivate events, to enable or disable the sending of certain types of messages between the application server 402 and the cloud platform 412. A request 426 can be sent by the enterprise messaging service instance 414 using the administrative OData service for remote control of channel and binding configuration. A configuration storage 427 can be used for maintaining event provider services, channels, channel parameters, and channel binding to event types.

Producer instances 430 can represent application server components that produce events. A producer instance 430 can be created by an event service provider to transmit events to the event enablement layer 408. For example, a business application 431 in the application server 402 can generate an event and send event information 432 to the business event handling component 404, for storage in an events queue 433. The eventing service 420 can receive the event information and forward the event information to a producer instance 430. The event enablement component 408 can, at run time, determine a binding 428 between an event type of the event and a channel 429. A channel 429 is an implementation of a channel interface. A channel interface is an abstraction between an eventing runtime and connectivity to the cloud platform 402.

An outbound handler 434 can receive the event information that is to be sent as outbound events. The outbound handler 434 can be associated with an event processor 436. The event processor 436 can be responsible for keeping an open connection 440 with the enterprise messaging service instance 414 of the cloud platform 412 (e.g., maintaining the connection 440 in case of connection failures). A messaging client 438 can send the outbound event(s), over the connection 440, to the enterprise messaging service instance 414. The messaging client 438 can implement a client API of a communication protocol, such as MQTT. A logging component 441 can log information about events that have been exposed by the application server 402.

The messaging client 438 can receive event information 439 from the cloud platform 412, and forward the received event information 439 to an inbound handler 442. The received event information can be sent to one or more consumer instances 444, which represent application server components that consume external events. A consumer instance can be created by an event service provider to receive events from the event enablement component 408. The consumer components 444 can interface with the eventing service 420 for providing received event information to applications (e.g., the application 431) or other application server components that have subscribed to receive external event information. The messaging client 438 can also receive an acknowledgement of a published event. The messaging client 438 can send a received acknowledgement 446 to a service implementation to be processed by a callback function 448.

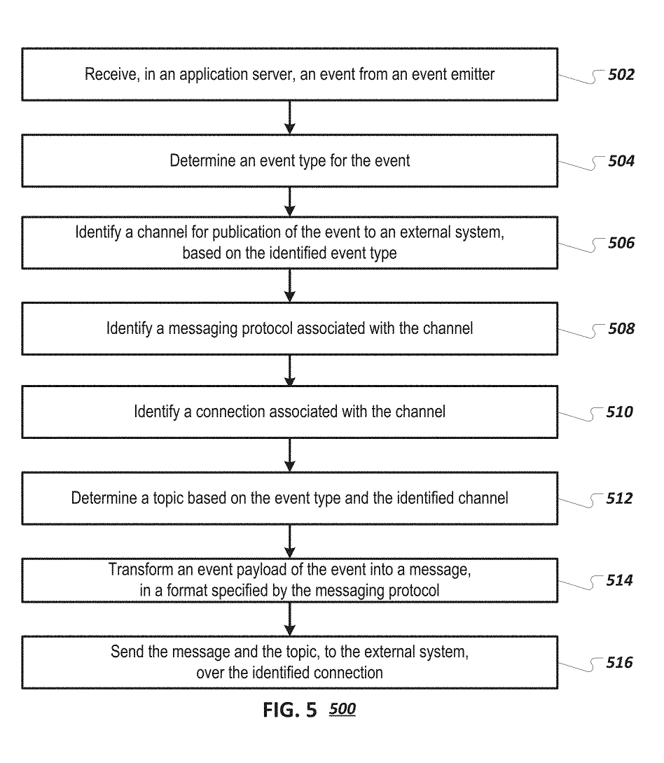

FIG. 5 is a flowchart of an example method 500 for sending an event from an application server to an external system. It will be understood that method 500 and related methods may be performed, for example, by any suitable system, environment, software, and hardware, or a combination of systems, environments, software, and hardware, as appropriate. For example, one or more of a client, a server, or other computing device can be used to execute method 500 and related methods and obtain any data from the memory of a client, the server, or the other computing device. In some implementations, the method 500 and related methods are executed by one or more components of the system 200 described above with respect to FIG. 2. For example, the method 500 and related methods can be executed by the event enablement component 208 of FIG. 2.

At 502, an event from an event transmitter is received, in an application server. The event transmitter can be a business component in the application server, for example. The event can occur as a result of a change to a business object, for example. The event can be received from the event emitter by an event enablement component included in the application server.

At 504, an event type for the event is determined. The received event can include a field or some other identifier that indicates the event type, for example.

At 506, a channel for publication of the event to an external system is identified, based on the identified event type. At least one channel that is bound to the event type can be identified. Identifying a bound channel can include identifying an existing channel that is bound to the event type or creating a new channel that is bound to the event type.

At 508, a messaging protocol associated with the channel is identified. The messaging protocol can be MQTT, a remote function call protocol, or some other type of protocol.

At 510, a connection associated with the channel is identified. Identifying a connection can include identifying an existing connection that is associated with the channel or creating a new connection and associating the new connection with the channel.

At 512, a topic is determined based on the event type and the identified channel. The topic can be a description for the event and can be used for routing the event to a target in the external system. One or more targets in the external system may have subscribed to the topic, for example.

At 514, an event payload of the event is transformed into a message that has a format specified by the messaging protocol. If the protocol is MQTT, for example, the message can be a MQTT message. If the protocol is the remote function call protocol, the message can be a function call with the event payload and the topic as function parameters.

At 516, the message and the topic are sent, to the external system, over the identified connection. If the protocol is MQTT, the message can be received by a message broker in the external system. If the protocol is the remote function call protocol, sending the message can include invoking the remote function.

The application server can also receive events from the external system. The application server and the external system can use event discovery services to discover events that may be published by respective systems. Events can be exchanged between systems using a unified eventing framework.

The included figures and accompanying description illustrate example processes and computer-implementable techniques. But the system (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 200 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method comprising:
receiving, in an application server, an event from an event emitter;
determining an event type for the event;
identifying a channel for publication of the event to an external system, based on the identified event type;
identifying a messaging protocol associated with the channel;
identifying a connection associated with the channel;
determining a topic based on the event type and the identified channel;
transforming an event payload of the event into a message, wherein the message is in a format specified by the messaging protocol; and
sending the message and the topic, to the external system, over the identified connection.

2. The method of claim 1, wherein the event is received from the event emitter by an event enablement component included in the application server.

3. The method of claim 1, wherein identifying the channel comprises identifying an existing channel that is bound to the event type.

4. The method of claim 1, wherein identifying the channel comprises creating a new channel.

5. The method of claim 1, further comprising receiving an external event from the external system.

6. The method of claim 5, wherein the application server and the external system exchange events using a same, unified eventing framework.

7. The method of claim 1, further comprising providing an event discovery service to the external system, to enable a user of the external system to browse a catalog of events that are published by the application server.

8. The method of claim 7, further comprising:
identifying a new event published by the application server; and
adding the new event to the catalog of events.

9. A system comprising:
one or more computers; and
a computer-readable medium coupled to the one or more computers having instructions stored thereon which, when executed by the one or more computers, cause the one or more computers to perform operations comprising:
receiving, in an application server, an event from an event emitter;
determining an event type for the event;
identifying a channel for publication of the event to an external system, based on the identified event type;
identifying a messaging protocol associated with the channel;
identifying a connection associated with the channel;
determining a topic based on the event type and the identified channel;
transforming an event payload of the event into a message, wherein the message is in a format specified by the messaging protocol; and
sending the message and the topic, to the external system, over the identified connection.

10. The system of claim 9, wherein the event is received from the event emitter by an event enablement component included in the application server.

11. The system of claim 9, wherein identifying the channel comprises identifying an existing channel that is bound to the event type.

12. The system of claim 9, wherein identifying the channel comprises creating a new channel.

13. The system of claim 9, further comprising receiving an external event from the external system.

14. The system of claim 13, wherein the application server and the external system exchange events using a same, unified eventing framework.

15. A computer program product encoded on a non-transitory storage medium, the product comprising non-transitory, computer readable instructions for causing one or more processors to perform operations comprising:
receiving, in an application server, an event from an event emitter;
determining an event type for the event;
identifying a channel for publication of the event to an external system, based on the identified event type;
identifying a messaging protocol associated with the channel;
identifying a connection associated with the channel;
determining a topic based on the event type and the identified channel;
transforming an event payload of the event into a message, wherein the message is in a format specified by the messaging protocol; and
sending the message and the topic, to the external system, over the identified connection.

16. The computer program product of claim 15, wherein the event is received from the event emitter by an event enablement component included in the application server.

17. The computer program product of claim 15, wherein identifying the channel comprises identifying an existing channel that is bound to the event type.

18. The computer program product of claim 15, wherein identifying the channel comprises creating a new channel.

19. The computer program product of claim 15, further comprising receiving an external event from the external system.

20. The computer program product of claim 19, wherein the application server and the external system exchange events using a same, unified eventing framework.
